(19) United States
(12) Patent Application Publication
(10) Pub. No.: US 2016/0334284 A1
(43) Pub. Date: Nov. 17, 2016

(54) SYSTEM AND METHOD FOR CALIBRATING AND CHARACTERISING INSTRUMENTS FOR TEMPERATURE MEASUREMENT BY TELEMETRY

(71) Applicant: Margarita KAPLUN MUCHARRAFILLE, Zapopan, Jalisco (MX)

(72) Inventors: Margarita KAPLUN MUCHARRAFILLE, Zapopan, Jalisco (MX); Victor MARTINEZ FUENTES, Santiago de Querétaro, Querétaro (MX)

(21) Appl. No.: 15/106,270

(22) PCT Filed: May 28, 2014
(86) PCT No.: PCT/MX2014/000080

§ 371 Date: Jun. 17, 2016

(30) Foreign Application Priority Data
Dec. 19, 2013 (MX) MX/A/2013/015367

(51) Int. Cl. G01K 15/00

(52) U.S. Cl. CPC G01K 15/005

(57) ABSTRACT

The invention relates to a more accurate system for calibration and/or characterization of temperature measurement instruments by telemetry, involving a reference unit with thermal gradient defined by a disc with thermal gradient, comprising at least one concentric heat diffuser metal ring, with temperature sensors that generate a staggered radial temperature profile mechanically linked with a cavity of a black body, housed in an electric furnace to produce and control the temperature thereof; a method for calibration of instruments for measuring temperature by telemetry; using a measurement subsystem for calibration of temperature measurement by telemetry, disposed opposite at least one said furnaces, consisting of a platform with longitudinal graduated scale as an indicator of distance, which is adapted to mount pattern equipment and the equipment to be calibrated; a PC, in which temperature readings of the reference ring system with thermal gradient of the cylindrical cavity of black body and, reference pattern equipment with traceability, are feed to obtain a temperature profile that allows, through a specialized mathematical calculation program based on comparisons, calibrate and/or characterize the temperature measuring instruments by telemetry.

### FIELD OF THE INVENTION

The present invention relates to the technical field of mechanics, metrology, thermometry, telemetry and infrared radiation, because it describes a disc with thermal gradient, comprising at least one metallic thermal diffuser ring and a cylindrical black-body cavity; an electric furnace comprising said disc with thermal gradient and the cylindrical black-body cavity, to generate and control its temperature; a method for calibration and characterization of temperature measurement instruments by telemetry.

### BACKGROUND OF THE INVENTION

Many industrial processes in which heating is involved either by application of heat or as a result of the operation of appliances, tools, equipment, machinery, etc., in certain production lines must have timely and accurate temperature control and exposure times and/or an operation that offers the best results of the process or the best equipment execution/performance. To achieve this control is necessary to properly measure the temperature, which should normally do without contact due to high temperatures, operator's unreachable areas or equipment handling high temperatures as ovens, among others. The current technological solution is to use infrared pyrometers (instruments measuring radiation in the infrared wavelength range emitted by the surface of the load in a given certain direction, temperature is related to the radiation detected magnitude within a fixed wavelength range)

Infrared radiation is electromagnetic radiation with wavelengths longer than those of visible light and it is shorter than millimetric radiation wave. Surfaces with a temperature greater than absolute zero (−273.15° C.) emit infrared radiation.

The range of infrared radiation wavelength is contiguous to the red light wavelength and occupies the range of 780 nm to 1 mm in the electromagnetic spectrum.

Infrared radiation can be subdivided into three ranges in field of measurement technology:

1. SIR (short infrared, 780 nm to 3 μm)

2. MIR (middle infrared, 3 to 5 μm)

3. FIR (far infrared [far infrared, 5. μm to 1 mm)

The most significant infrared measurement technology is FIR in the range 5-20 microns.

The temperature of an object can be measured from its spectral radiance. A thermometer that works under that principle is called radiation thermometer, and the temperature measured is called radiance temperature.

Infrared thermometers measures the electromagnetic radiation emitted by an object which results of its temperature. When an object reaches high temperatures, most of its radiation is in a band of wavelengths called infrared spectrum. The hottest objects emit visible light, which is also a electromagnetic radiation.

Human eye is very sensitive to yellow light with wavelengths around 0.555 microns, but cannot detect light with longer wavelengths than 0.700 microns (red) or shorter than 0.400 microns (violet). Nevertheless our eyes can not detect the energy out of that narrow band of wavelengths called visible spectrum, It is known that they exist because can be detected with a radiometer.

Infrared thermometers are designed to be sensitive in a specific band of wavelengths. The spectral band most widely used goes from 8 μm to 14 μm (8 to 14 micrometers).

Infrared radiation is electromagnetic radiation with wavelengths larger than visible light and smaller than the millimeter wave radiation wavelength. Wavelength and amplitude are terms used to describe infrared radiation and other types of electromagnetic radiation. As an example, the wave amplitude describes the intensity of electromagnetic radiation and the wavelength is used among other things to determine if it is microwave, visible light or infrared radiation.

Infrared thermometers are used in a great variety of situations where contact measurements are not possible. Applications covered by these devices are multiple and include a growing number of analysis possibilities day to day, comprising large application fields from the aeronautics until commonly used applications, as it could be health, so that confidence in these measures increases with calibration.

Infrared thermometers have an optical resolution defined by the relationship between object distance and the diameter of the area containing a specific percentage of the total energy collected or spot size, it is represented as the ratio distance to spot size (D:S), this ratio is used as a guide to determine the appropriate distance to do infrared temperature measurements.

A thermal imaging camera for the spot size represents the pixel and the distance you can see, while the instantaneous field of view (IFOV) is the solid angle subtended from the pixel to the camera lens.

A narrowband radiation thermometer is one that has an optical filter, which transmits a narrow interval of wavelengths. This interval is called spectral bandwidth (Δλ), that it is within few nanometer's order (nm).

A broadband radiation thermometer is one that is characterized by an optical filter, which transmits a larger interval of wavelengths (Δλ); this interval is about several micrometers (μm).

The correct control and readout of process temperatures is very important in industrial processes, as well as those of the equipment and machinery used in such processes. Many important industrial decisions are based on the results of measurements from process and equipment conditions. Stopping a production line in order to do repairs and maintenance can result in large economic losses, when is caused by temperature control problems, due to failures or errors in measurement or with the wrong readings. There is no doubt that in order to fully rely on the measurements, is of major importance optimal calibration of instruments for measuring temperature.

Calibration is operation that, under specified conditions, in a first step establishes a relation between the quantity values with measurement uncertainties provided by measurement standards and corresponding indications with associated measurement uncertainties and, in a second step, uses this information to establish a relation for obtaining a measurement result from an indication. (NMX-Z-055-IMNC-2009).

A reliable calibration presupposes greater accuracy of readings, less worries, fewer questions and increased productivity.

Confidence on infrared radiation measures as a rule requires the use of calibrated instruments. Calibration can also be defined as the set of operations carried out according to a defined calibration procedure, which compares the measurements made by an instrument to those made with an instrument of higher accuracy or standard, with purpose to detect and report or adjust or eliminate errors in the instrument being calibrated.

The measurement standard usually used to calibrate and/or verify measuring instruments or systems, is an instrument which is known behavior and serving as a reference to calibrate the “calibrated measuring instrument”. (NMX-Z-055-IMNC-2009).

The reference measurement standard is the measurement standard designated for the calibration of other measurement standards for quantities of a given kind in a given organization or at a given location. (NMX-Z-055-IMNC-2009)

In the calibration process it may exist error of measurement defined as the difference between measured quantity value minus a reference quantity value (NMX-Z55-IMNC-2009).

There are also non-negative parameters characterizing the dispersion of the quantity values being attributed to a measurand, based on the information used. (NMX-Z55-IMNC-2009, it is defined as measurement uncertainty.

An infrared temperature calibration begins with a surface extension, which acts as a heating source, which should be a flat plate or a cavity which functions as measurement standard or reference. The geometry of calibration, that include the size of the measuring surface and the thermometer's distance, plays a fundamental role in the measurement result. Temperature stability, uniformity, physical properties of the emitting surface and emissivity are also critical.

Emissivity is the radiant energy from an opaque surface is a combination of the radiance emitted caused by surface temperature and radiance reflected from anywhere in the surroundings.

The quantity of light emitted at a given temperature is determined by the emissivity of the surface. Emissivity is the ratio of energy radiated emitted by a surface and that emitted by a black body at the same temperature. Emissivity is greatly affected by the type of material and the surface finishing thereof.

Infrared temperature calibrators must be designed to have a known emissivity, which must remain constant over time.

The emissivity can be any value between zero and one, inclusive. Zero emissivity indicates that no matter what the temperature of the body because no light is radiated. An emissivity of one indicates that the surface radiate perfectly to all wavelengths. The “black bodies” are perfectly radiant objects. Objects with emissivity very close to one commonly called black bodies. A calibrator with a flat surface and an emissivity around 0.95 is often called gray body if the emissivity is uniform for all wavelengths.

Some radiation thermometers manufacturers, if not most, assume a constant emissivity value for any object or source, which is independent of temperature and wavelength. However, in most cases it is not true: the emissivity of bodies in general depends on both the temperature and the wavelength. Only for an ideal black body it holds that the value of its emissivity is independent of temperature and wavelength.

Black body is an ideal surface that absorbs and emits electromagnetic radiation with the maximum amount of power at a given temperature according to Planck's Law, where:
c1L is the first radiation constant for spectral radiance, with value 1,191 042 759×10⁻¹⁶ W·m²·sr⁻¹
λ is the wavelength in meters.
c2 is the second radiation constant, with value 1,4388×10⁻² m·K
T is the back body temperature in Kelvin degrees.
LCN(λ, T) is the electromagnetic radiation emitted, also called spectral radiance because involves physical properties of the source, such as:
   radiated power, in W,
   the source area, in m2,
   the solid angle in sr.

Such ideal surface emits and absorbs electromagnetic radiation, does not allow reflect or pass radiation through it. At laboratory a black body is a long cavity with a small opening. Reflection is avoided because any light coming through the hole must be reflected on the surface of the body often being absorbed before escaping.

When it meets c2/λT>>1, you can use the Wien law for the spectral radiance of a black body:

A gray body is a surface that emits radiation with a constant emissivity over all wavelengths and temperatures. Although gray bodies do not exist in practice, they are a good approximation for most real surfaces.

Currently there exist blackbodies for calibration of temperature radiation measurers, mostly infrared thermometers and equipment. These bodies exist commercially and consist of cavities, which by their physical characteristics of construction and the materials used have achieved a high emissivity value, a critical variable in this field of the invention.

International brands such as Land®, Hart Scientific (fluke)®, Isotech®, Wuhan Guide®, Infrared Systems®, among others are best known for their quality and have extensive temperature ranges.

Some of the black bodies are not hollows, but rather surfaces and these are also used to calibrate radiation thermometers, radiation exposed surface is preferred for infrared thermometers with large viewing angle.

Blackbodies having forms of discs or plates do not determine the thermal gradient; in addition provide “point” temperature measurements without covering the wide range of sizes of matrices implicated by thermographic equipment.

Existing blackbodies are useful for calibrating IR thermometers, but not for infrared equipment, because measurement principle is different. The temperature of the infrared thermometer is the average of the temperatures measured in the circle resulting from the measurement angle, whereas the temperature measured with infrared equipment is result from capturing the measured body's radiated energy, represented by a matrix with punctual temperature values in X, Y.

The equipment described above has deficiencies that preclude calibration and characterization of infrared equipment. Blackbodies produce an isolated temperature point that calibrates a single temperature value in the thermal camera (thermal imager or thermal imager camera), there is no way to possess a known thermal gradient in order to calibrate the temperature differences that records the thermal imaging camera.

In the case of black surfaces, despite having thermal gradients, these are determined in such a way that can not be compared with those shown in thermal imaging camera. Therefore, nowadays existing equipment are designed to calibrate infrared thermometers but not for thermographic equipment.

Existing black bodies are useful for calibrating infrared (IR) thermometers, but not for infrared cameras, since their measuring principle is different. The temperature of the infrared thermometer represents the average of the temperatures measured in the circle resulting from the measurement angle, whereas the temperature measured with the thermal imager is resulting to capture the radiated energy of the measured body, represented by a matrix (X, Y) with specific temperature values.

Temperature magnitude's traceability to the measurement standards of International System of Units is given through a control thermometer, in commercial equipment.

Making a prior art searching, were found some patents related to infrared technology, as international patent application published 9 Jul. 2007 with number WO2008031774 from Goldammer and Heinrich Matthias Werner, which relates to a method for determining parameters of a component by means of thermography, wherein the at least one component is heated by means of a hot gas. The invention further relates to a device for determining component parameters by means of thermography with a heating means for heating at least one component, with a temperature sensor for detecting at least one temperature value of the component, wherein the heating means for heating the component is a hot gas emission device for the emission of modulated, especially pulsed, hot gas.

Patent number EP1726943 from Kevin D. Smith, of 12 May 1997, which describes an inspection apparatus, includes a light source positioned to direct light to a first surface of a work piece. An infrared detector is positioned to receive radiation from the first surface. A data acquisition and processing computer is coupled to the light source and the infrared detector. The computer triggers the light source to emit the light a number of instances. The computer acquires thermal data from the infrared detector for a number of times after each of the instances. The computer is configured to process the data using a theoretical solution to analyze the thermal data based upon an average of the thermal data for a number of each of corresponding ones of the times from different ones of the instances.

Other documents found with little or no relevance, but are cited as reference are the documents GB1345622 and JP5093655A

None of the cited and localized documents disclose or suggest a system and method for calibration and characterization of temperature measuring instruments by means of the telemetry, such as the present invention.

Given the need of a system and method for calibration of thermographic equipment and temperature measurement instruments via infrared, which would solve the disadvantages of the equipment and methods calibration existing, which are unsuitable for thermographic equipment, it was that the present invention was developed.

### OBJECTIVES OF THE INVENTION

The present invention has as its first objective, make available a more accurate system for calibrating and/or characterizing, temperature measuring instruments through telemetry, involving a reference unit with thermal gradient, an oven comprising said unit reference in order to generate and control its temperature; and a method for calibration characterization of temperature measurement instruments by telemetry.

Second objective of the invention is to make available such a system for calibrating and/or characterizing more accurately, temperature measuring instruments through telemetry; further to define and meet a thermal gradient required needed to calibrate the temperature differences recorded by the thermographic equipment.

Third objective of the invention is to set out a method for calibrating and/or characterizing, temperature measuring instruments through telemetry effectively, under the existing regulation with good values of uncertainty.

Another objective of the invention is to make available such a method for calibrating and/or characterizing, temperature measuring instruments through telemetry, which allows temperature analysis in order to determine thermographic equipment's characteristics.

And all those qualities and objectives that will be apparent while is conducted comprehensive and detailed description of the present invention, supported in the illustrated embodiments.

### SUMMARY OF THE INVENTION

The invention was developed to solve primarily, the technical problem that precludes determine the temperature gradients in a metal disc, to thereby to calibrate and/or characterize thermographic equipment; therefore the present invention provides defining the heat loss in the discs due to thermal convection and radiation. To this end was created a model of heat loss as a function of temperature using Fourier's heat transfer equations, Newton's law of cooling and Stefan-Boltzmann's law. The heat convection transfer coefficients were determined from empirical equations of free convection in air for vertical plates.

Generally, the system for calibrating and/or characterizing, temperature measuring instruments through telemetry, in accordance with the present invention comprises at least an electric furnace with temperature controller ramped, containing a cylindrical cavity of black body, containing temperature sensors for calibrating and temperature measurements tracing of infrared thermometers and thermographic equipment; wherein said cylindrical cavity black body comprises a disc with thermal gradient mechanically linked around the entrance of the cavity of said black body, and is composed of a plurality of concentric rings with temperature sensors that generate a radial profile of staggered temperatures by heat loss by convection and radiation in each ring in order to define temperature profiles with temperature gradient by thermal contact with the cylindrical disc cavity of black body, which is heated by an electric heating; heating spreads from the cavity of black body towards the end of at least one of the rings, causing a loss of heat, while heat flows from the center to the end in minor proportion; wherein said furnace comprises a controller device self-adjusting temperature with a data acquisition system where the temperature sensors of said concentric rings are connected, and in turn said data acquisition system is connected to a personal computer (PC) or computer equipment comprising a specialized mathematical computation program that processes information to obtain the behavior of the furnace, for indicating the behavior of the temperature over time, and may meet the required variables to determine the value of thermal gradients of rings; a positioning and measuring subsystem for calibrating and/or characterizing, temperature measuring instruments through telemetry, arranged in front of at least one oven, comprising a platform with longitudinal graduated scale as an indicator of distance, that can approach the furnace to a distance minimum of 0.15 meters or move away to a distance of 1.5 m; and which it is adapted to assemble the measurement standard, the equipment for calibrating, and means for centering and leveling both, at the center of furnace cavity of black body; the measurement standard or pyrometer measures the temperature at the center of furnace cavity of black body, and continuously compares with the temperature displayed on the screen of the oven; once the temperature in the furnace is achieved, the temperature reading is taken; subsequently, but almost immediately, while the oven is stable, a reference thermal camera takes temperature readings of all objects that can perceive its viewing angle, mainly the cylindrical cavity of black body and the set of concentric rings assembled thereof; and takes an infrared image with temperature values at all pixels on its detector; this may determine thermal gradients with a known size; immediately reading is taken with the instrument to be calibrated and/or characterized and said temperature is recorded to be compared with the temperatures previously captured by the measurement standard.

The temperatures data collected from the measurement standard, the equipment to calibrate and the oven, as well as temperature readings that define the thermal gradients of the concentric rings of the disc, all of them are fed to said PC and using the computer program, thermographic equipment is calibrated, because with the reference rings system with thermal gradient will be known temperature behavior along reference disks, while being known the temperature of the cylindrical cavity of black body and traceability with reference to national or international standards through the measurement standard or calibration pyrometer and the sensors system for calibration of temperature. A temperature profile is obtained, which by direct comparison, allows calibrate and/or characterize temperature measuring instruments by telemetry. To characterize a thermography equipment using the invention, the reference thermal imaging camera takes temperature readings from different positions, preferably at least ⅛ of central area of black body's cavity must always be included in measurements, whereby the detector of the thermographic equipment which is measured will capture (will census) the maximum temperature in different parts of its detector area, thereby determining the detector behavior of the instrument to be calibrated and thus their characterization in different quadrants, establishing its behavior.

In the preferred embodiment of the invention, the cylindrical cavity of black body is cylindrical and is constructed with high thermal conductivity materials to provide good heat transfer to the end one or more rings, which compose the reference disks with thermal gradient, thereby causing heat diminution, as it moves away from the center of black body cavity towards the end. The cylindrical cavity of black body has optimal ratio of opening: cavity's length, which provide high emissivity.

The cylindrical cavity of black body is longitudinally heated through an electric heater whose purpose is to try to maintain stable and uniform a predetermined temperature value. This stability is achieved by means of a temperature controller with digital ramp; the cylindrical cavity of black body includes at least one temperature sensor and a temperature sensor for controlling the same. These sensors are calibrated and inserted in said cavity, thereby providing traceability to national or international standards.

In the preferred embodiment of the invention, the cylindrical cavity of black body has two temperature sensors, or resistance temperature detectors (RTD) or K type thermocouple, which depend on the temperature range to be measured, located on the back of the black body cavity. On the back of each thermal diffusers metal rings are inserted at least two sensors, preferably thermocouples temperature and/or resistance thermometers. Therefore, the disc with thermal gradient, comprised of one or more metal rings thermal diffusers, has at least eight calibrated temperature sensors, a greater number of sensors is preferred for greater accuracy in measurements (18 sensors, including those contained in the black body cavity). All sensors provide to system, traceability to national or international standards.

In one of the embodiments of the invention said thermal diffusers metal rings are made of a square profile, has frontal, rear and lateral outer surfaces; such ring characterized for comprising concentricity, a fluted of triangular profile on the outer surface of its front side, showing triangular grooves (equilateral) in cross section; a smooth rear surface; at least two cavities located in the smooth rear surface, horizontally oriented with respect to the axial axis of the ring; and at least two temperature sensors embedded in said cavities.

In other embodiments of the invention, the surfaces of said concentric thermal diffusers metal rings, are blackened in order to increase its emissivity. Methods for blackened depend on the construction material of the rings. For aluminum is a dark anodized, for brass is oxidized and matt black paint, for Inconel® is surface oxidized at high temperatures and/or matt black paint.

In the preferred embodiment of the invention, at least one heat spreader metal ring composes the thermal gradient disc, but four concentrically arranged rings are preferred, and cylindrical cavity black body at its center. Thermal gradients are created in the rings due to disc's thermal contact with the cylindrical cavity of black body that is heated by an electric heater. Heat transfer is transmitted from central cavity of black toward the ends of the disc body, thermal gradient through the thermal contact of the ring with the smallest diameter in the cavity of black body. The thermal contact between the rings on the disk creates a thermal resistance, which depends on contact pressure, surface finish and thermal properties of the rings on contact. The thermal resistance in turn provides noticeable and abrupt temperature difference, which generates a series of temperature steps or stages in the contact interface between rings. Within the rings outside the interface, a thermal gradient with soft profile is created in the radial direction. This gradient is due to heat losses by convection and radiation, such characteristics are which allow the calibration of infrared thermometers and thermal imaging equipment, and equipment characterization related to the temperature gradient.

In the preferred embodiment of the invention, the system comprises a temperature range for calibration of equipment between 50 and 800° C. and it preferably include three electric ovens with temperature controller with digital ramp, which depending on the measurement range of equipment to calibrate would have a furnace for low temperatures between 50 C and 300° C., an oven with average temperatures between 150 and 550° C. and a furnace for high temperature between 500 and 800° C., to calibrate and/or characterize the equipment.

In the preferred embodiment of the invention, said electric furnace with temperature controller with digital ramp consists of a housing that protects and housed in an isolated thermal enclosure the cylindrical cavity of black bodies through thermal insulation brackets, and exposes frontally the disk with thermal gradient formed by the plurality of concentric rings at the input of black body cavity; said housing comprises lower supports where heat sinks are mounted, which are anchored on a control cabinet housing a controller device temperature with digital ramp, output data screen, ventilation means, panel universal wiring, fuse elements, switch and a general electrical control.

The concentric reference rings with thermal gradient bind to the cylindrical cavity of black body mechanically in their centers; when joined are placed on an insulating support of low thermal conductivity. To thermally insulate the entire assembly from heating and black body heating, thermal insulation around the heater and the black body is used. The thermal insulator is a ceramic fiber with low density and thermal conductivity, placed around.

The black body heater is electric has enough power and superior in excess heat losses. It is half-round and fully embraces the black body. The heater has mica electrical insulation. It is designed to connect to the mains 220V.

It has a temperature controller with digital ramp, which has the capability of auto tuning to find the optimal control values and the heating capacity in ramps. It has an external power driver whose capacity depends on the apparatus's temperature interval.

The eighteen temperature sensors both from concentric rings as in black body interior, connects coming out the electric oven to controller located on the oven's bottom within the control cabinet, temperature is shown on the output screen.

The temperature controller with digital ramp, has the auto tuning capability to find the optimal control values and by ramps heating capacity. It has an external power driver whose capacity depends on the temperature range of the apparatus.

In turn, the temperature sensors come out the controller to a data acquisition system that is located associated to the ovens. A PC is connected to said acquisition system and information is processed through a mathematical computational specialized program to obtain the behavior of the furnace for obtaining the behavior of the temperature over time and may know this way, the variables required for determine the value of thermal gradients of the rings. Making reference to information of the technical guide on traceability and uncertainty in the calibration of radiation thermometers, then procedures are presented using the method of comparison with the following cases:
Case 1. Compare the temperature of radiance of a black body (known source characterized by NIST) measured by the radiation thermometer IBC, where the black body temperature is measured up to 300° C. with a platinum RTD, and 300° C. onwards with a S thermocouple, both devices as measurement standards.
Case 2. Compare the temperature of radiance of a known source of radiation measured with the radiation thermometer under IBC calibration, against temperature of radiance measured by a calibrated radiation thermometer, used as referent measurement standard.

Characteristics of the elements of the measuring system.

Radiant Sources:

Five types of radiation sources are generally used in measurements:
Black bodies with fixed points of the International Temperature Scale of 1990.
Cavity of a heat pipe closed at one end.
Cavity of a variable temperature oven electrically heated, with one or more heating zones.
Variable temperature hot dish, with known emissivity.

The chosen option for the present invention is the cavity of a black body, with an additional arrangement of at least one ring metal heat spreader (preferably four), that make up the disc with thermal gradient, placed in a variable temperature oven with a heating zone by electric heating. The temperature is controlled by a control with ramps.

Requirements for Radiation Sources:
The opening of the cavity of the black body, or the radiator, must have a diameter at least twice larger than the diameter of the IBC's visual field, any of the established distances for calibration.
The value of the emissivity of the black body, which is regarded as an isothermal cavity, should not be less than 0.90.
The value of the emissivity of radiation sources different to black bodies must have evidence of its validity.

Consequently the measurement system is:
A radiation source (cavity) characterized of opening 38 mm, depth of 19 cm, interval between three cavities, from 50° C. to 800° C. and a radiation thermometer calibrated in the same measuring range or better, with traceability national or international standards.

Equipment designed to calibrate and/or characterize thermal cameras and infrared thermometers is described in the system of the present invention, based on a cavity of black body, joined to a disk with thermal gradient, said disc consists of at least one thermal metal ring diffuser (preferably four), as described and which will be described in detail in the detailed description of the invention (below) and which is shown in the accompanying figures.

Requirements for Radiant Source Used:

Consequently the measurement system is:
A radiation source (cavity) characterized of opening 38 mm, depth of 18 cm, the interval between three cavities from 50° C. to 800° C. and a radiation thermometer calibrated at the same measurement interval.

Before a calibration it is required to know the features and specifications of the following elements and thus to determine the scope of calibration.

a) Environmental conditions:

To properly perform a measurement with the thermal camera should be taken into account the following environmental conditions:

1. Ambient temperature:

The ambient temperature influences the reflected temperature. In many cases there are only a few Celsius degrees between room temperature and reflected temperature.

If there is air conditioning is recommended laminar flow control specifications 23° C.±3° C.

2. Moisture:

The relative humidity must be low to prevent condensation in the cavity and plates of thermal gradient to measure and in the protective lens filter or in the same lens.

3. Air currents:

An air stream can affect the cavity or the dishes, convection drags heat from a warm object and transfers it to a cold object until air temperatures and object have equalized.

4. Light:

The light has no significant impact on the measurement with a thermal imager. In principle, they could also make measurements in the dark. However, some light sources emit infrared radiation and therefore affect the temperature of the dishes. So, should not take measurements near an incandescent bulb. LEDs or neon lights, however, do not have this type of problem because they emit most of the energy received in the form of visible light and not as radiant heat.

In general it is recommended to be monitored and controlled values of temperature and humidity.

For the proper care and operation of instruments should not exceed the tolerance limits because the internal electronic components depend on the temperature and humidity to have a good performance.

It is important to notify that the power supplied for the operation the different equipments must corresponds in voltage and frequency, as there may be differences between the manufacturers' specifications; therefore it is recommended to have a system of protection and regulation for electronic equipment.

b) Measurement standards: Know their accuracy (errors and uncertainty), measuring range, units of measurement, emissivity or radiance of the surface of the discs with thermal gradient and cavity of black body, optical resolution and calibration validity.

c) Facilities for temperature generation: Electric oven (containing inter alia the cylindrical cavity of black body and disc with thermal gradient, which comprises at least one concentric ring, while four are preferred). They are characterized by their status in temperature, emissivity or radiance of the disc surface with thermal gradient and distance information to which these were measured, report evidence or measurement or calibration certificate. Be determined temperature range, location and dimensions where the instruments are located.

d) Subsystem for positioning and measurement.

The platform to have what it takes to place, secure and level the instruments to be calibrated, this includes:

e) Accessories: Anything that does not have to do directly but helps calibrate, as structures, brackets, fasteners, optical cleaning cloths.

The calibration and/or characterization method of temperature measurement instruments by telemetry with a greater accuracy, in accordance with the present invention, comprises the not limitative following suggested steps:

a) Gather information from instrument to be calibrated;

b) Clean the instrument to measure, such as infrared radiation thermometer or thermal imager;

c) Condition the oven to use, based on the measuring range of the instrument to measure IBC. According to the following table:

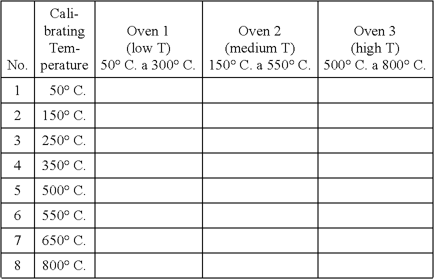

d) Perform and register a visual inspection;

e) Calibrate and/or characterize the temperature measurement instruments by telemetry.

Calibration Process

When the instrument to measure satisfactorily passed visual inspection and there is not inconvenience for calibration, it proceeds to:

1) Turn on the oven and using the temperature controller with digital ramp, set up the first temperature required to calibrate;

2) Wait long enough for electric furnace reaches stability; ramp temperature controller allows the oven to remain stable for a considerable and adequate time for doing measurements to different measuring equipment: measurement standard and instrument being measured;

3) Place both the reference or measurement standard P and the instrument being measured IBC at the positioning and measurement subsystem, review both measuring instruments have been programmed for the same emissivity;

4) Place the support at a selected proper distance, based on the visual field, level and line up in direction of the cylindrical cavity of black body of the oven;

5) Perform a positioning test, if possible and the instrument to measure allows it, aligning test is made with a laser pointer ensuring that the centers at both the standard equipment as the instrument being measured IBC and the center of the cylindrical cavity of black body were aligned with reference to its center.

6a) In the case of infrared radiation thermometers calibrated, readings shall be taken as follows: (LP-LIBC-L-LP-LP-IBC IBC L-LIBC IBC-LP-LP-L-LIBC-LP), as shown in the following table:

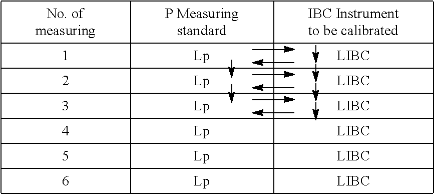

Where:
LP corresponds to the reading of pyrometer standard (or pattern pyrometer).
LIBC corresponds to the reading of the instrument to be calibrated.

6b) In the case of to calibrate thermographic equipment or thermal imagers, readings shall be taken as follows: (LP-CP-LIBC-LIBC-CP-LP-LP-CP-LIBC-LBC-CP-LP-LP-CP-LIBC-IBCL-CP-LP), as shown in the following table:

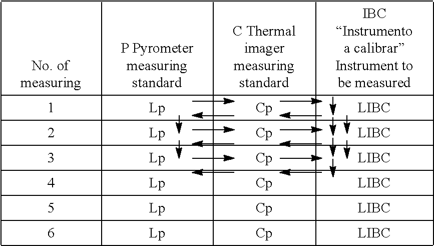

Where:
Cp corresponds to the reading of thermal imager standard, standard thermal camera (measuring standard or pattern).

7) It is also recorded at the beginning and end of each measuring point, the room temperature close to IBC instrument. Also it considered the value of the emissivity, which is working, spot used, actual positioning distance to the cylindrical cavity of the black body and spectral response of the IBC instrument.

8) Measure using the different instruments of measurement: At this time, the pattern pyrometer measures the temperature of the electric furnace, and recorded manually on a PC, when the temperature shown on the display data output has been stabilized. Immediately afterwards, the temperature is measured with a standard thermal imager and recorded manually and a thermal image is taken with a pattern thermal imager, which is stored in its internal memory and then downloaded to a PC. Finally the instrument being measured, such as, infrared thermometers or thermal imagers measure the temperature of the oven, and recorded manually on a PC.

9) Repeat this series of steps at least five times and carry out the corresponding temperature records.

10) The temperature measurements from the sensors, located on the back of both concentric metal rings diffusers thermal, as the sensors of the cylindrical cavity of black body 2, are electronically acquired by the data acquisition system and transmitted so electronics to a PC.

11) The data collected from measuring standards (P: patterns), instruments being measured (IBC) and temperature sensors electric furnace equipment, as well as temperature readings that define thermal gradients (taken with the standard thermal camera) of concentric thermal diffuser metal rings of the disc with thermal gradient are fed to said PC and using the computer program, the necessary mathematical calculations are performed to determine the behavior of the instrument being measured, taking as a calibration method such based on direct comparison, because with the concentric thermal diffuser metallic rings system, located on the disc with thermal gradient, in addition to knowing the temperature of the cylindrical cavity of black body and traceability with reference to the pyrometer pattern, allows to know the size of the thermal gradient and therefore may characterize equipment or thermal cameras, because the behavior of the temperature along the disc with thermal gradient it is known. Thereby obtaining radial temperature profile starting from the center of the cylindrical cavity of black body until the end of the disc with thermal gradient;

12) If the measuring instrument is a thermal imaging camera, specifically speaking, this additional step is considered for characterizing the same and is performed as follows:

i) The thermal camera that is the measuring standard takes a thermal image, capturing thus temperature readings in electric furnace front side in different positions, preferably always must be included in measuring at least ⅛ of the center area of the cylindrical cavity of black body, with which the detector of the thermographic equipment to be measure takes (will capture a census) the maximum temperature value in different parts of its area detector, thereby achieving determine the behavior detector instrument to be calibrated and thus their characterization in different quadrants, thus determining its behavior.

ii) After the thermal image taken, it is stored in the internal memory and later downloaded to a PC.

iii) This jack thermal imaging is performed at least four times in different positions covering at least ⅛ of the area of the center of the black body cavity.

iv) Prepare the calibration certificate electronically, considering all the data acquired by the data acquisition system and transferred to the PC. This document involves making known the measurements taken during the calibration process and deviations that the instrument to be measure have with reference to the measuring standard equipment, specifying the error that it has and its associated uncertainty associated variables which had affected on the measurement during the calibration process.

The estimated uncertainty associated with the method when the temperature is calibrated is:

e_{ct}=t_{ct}−C_{ε}−tₚ

Where:

e_{ct} is the error obtained in the thermal imaging camera calibration.

t_{ct} is the temperature reading of the thermal imaging camera under repeatability. The uncertainty involved is the repeatability of the instrument and resolution.

C_{ε} is the emissivity correction when you can not adjust the thermal imaging camera to match that of the black body cylindrical cavity. The uncertainty of this parameter is determined by the uncertainty of the effective emissivity of the black body cylindrical cavity, from the emissivity of the walls thereof.

tₚ is the temperature of the black body cylindrical cavity obtained with reference to the pattern pyrometer. The uncertainty is calculated based on the calibration reference standard pyrometer and measurement errors temperature (uniformity, heat transfer).

The estimated uncertainty that is associated with the method when the calibration is carried out at temperature differences (thermal gradient) is:

Where:

e_{Δt}=Δt_{ct}−Δt_{d}−C_{Δt}_{_{d}}−Cₚₜ−C_{ε}

e_{Δt} is the error in the measured temperature difference with the thermal imager camera, and temperature differences observed in the disc with thermal gradient, between two given positions thereof.

Δt_{ct} is the average temperature difference measured with the thermal imager between two specific positions of the disc with thermal gradient.

Δt_{d} is the average temperature difference determined with thermocouples arranged differentially between two points in certain positions of the disc with thermal gradient.

For this method, the temperature range is from 50° C. to 800° C., and it has been divided into three building materials: aluminum, brass and Inconel®, for sub ranges from 50° C. to 350° C., 150° C. to 550° C. and 500° C. to 800° C. respectively. The main reason for selecting these materials is based on its high thermal conductivity and stability in the respective temperature ranges.

For this, the following table shows the measurement range of the present invention for calibrating and/or characterizing thermal imagers and infrared thermometers:

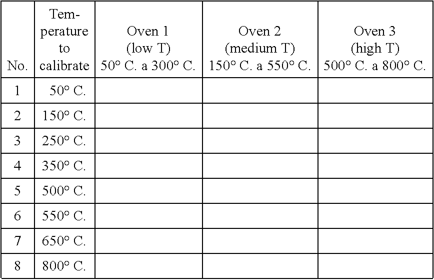

The main feature of her present invention is the use of a disk with thermal gradient, which is linked mechanically to the black body cylindrical cavity. Temperature gradients in the disc with thermal gradient produced by two main factors: the use of at least one concentric thermal diffuser metal ring, preferably four concentric thermal diffusers metal rings that make up the disk, attached to the cylindrical cavity of the black body, whose purpose is to create steps in the radial temperature profile; heat loss by convection and radiation in each ring to give temperature profiles with small slope. These characteristics are which allow the characterization of cameras regarding the temperature gradient.

The configuration for disk with thermal gradient conformed by at least one concentric thermal diffuser metal ring is described in the detailed description.

Thermal gradients are quantized as follows:

Gradient=ΔT/ΔL

Where:

ΔT is the temperature difference between two consecutive points and,

ΔL is the distance between two consecutive points. The temperature difference is measured mainly with calibrated thermocouples.

The distance between two consecutive points is known from the design and construction of the thermal diffusers metal rings.

Example for calculation of the compensations introduced by a radiation thermometer, which operates to an emissivity adjustment different to 1.

In literature you can find several proposals to determine compensation to the measured temperature of an object that is not a black body, depending on its emissivity and its temperature.

In general, the value of the emissivity usually varies for different wavelengths of the spectrum emitted by a radiation source and for different temperatures at which the source can be found.

However, mean values can be determined for the emissivity of the radiation source for both band spectral response measurement pattern as the IBC, which can be operated as if it were independent of the wavelength of that band.

With such emissivity value, the output signal B (T) product of the radiance of a radiation source that is not a black body, is compensated by the ratio of that signal and the emissivity:

B′(T)=B(t)/ε

In this way, a signal value that would be equivalent to a black body which is at the same temperature of the object being measured is obtained and this value to determine the value of the source temperature.

Calculation and Estimation of Uncertainty

They are obtained from the measurement data by calculating the corresponding means (averages) of the measuring standard, and the instrument to calibrate. Further if there was any correction, this adds to the value of the average to obtain final value.

Measurement error, it is equal to the difference Instrument (C) to be calibrated and the measuring standard or pattern (P),

Error=LIBC−LP

The process calibration implications tell the difference between the Calibrating and Pattern. So which is find an “error”; this value is signed and is associated to an uncertainty. Unlike single measurement process, the latter is associated to a value of measurement uncertainty. That is after making a correction to the indicated value, this has a measurement uncertainty. Sometimes it is not practical to perform the correction and measurement uncertainty is estimated as the algebraic sum of error and uncertainty of error.

Also in the calibration of a measurement instrument, it is assumed that the measuring standard or pattern (P) has a smaller uncertainty than the instrument to calibrate or calibrating (C), therefore, the combination of the uncertainties can be estimated that the result tends to uncertainty of the calibrating; so if a correction is made to the instrument, the uncertainty of error is equivalent to the measurement uncertainty (in the calibration conditions).

Measurement Uncertainty:

In addition to error, it is associated the value of uncertainty.

This parameter allows us to assess the quality of the measurement, indicated by an interval in which we are certain that the conventional true value lies. In the uncertainty affect all means influencing the measurement, clarifying that the quality of the thermometer to calibrate also has consequences in this value.

Uncertainty

Uncertainty type A. Obtained by statistical methods and expressed in terms of the sampling standard deviation of the mean (σₓ):

$${σ}_{x} = t \frac{σ}{\sqrt{n}}$$

Where σ is the standard deviation typical and n the number of samples

Uncertainty type B. Because the information collected by non-statistical data:

$${u}_{B} = \frac{Specification}{2 \sqrt{3}}$$

| | | BRIEF |
|---|---|---|
| ASSOCIATED TO: | UNCERTAINTY | DESCRIPTION |
| INSTRUMENT TO | 1. IBC-RESOLUTION | Screen resolution of |
| BE CALIBRATED | | items shown by IBC |
| | 2. REPEATED | Dispersion of the |
| | MEASUREMENTS | readings obtained from |
| | OF IBC | the IBC |
| | 3. COMPENSATION DUE | When the IBC can not |
| | TO EMISSIVITY | be adjusted to the |
| | ADJUSTMENT | emissivity value of |
| | | the source. |
| | | Note: Only applies |
| | | to radiation |
| | | thermometers, if |
| | | not corrected. |
| RADIANT | 4. TEMPERATURE | Calibration certificate |
| SOURCE | MEASUREMENTS | |
| (BLACK BODY | 5. VALUE OF ITS | Calibration certificate |
| CAVITY) | EMISSIVITY | |
| | 6. CALIBRATION AREA | |
| TEMPERATURE | 7. CERTIFICATE OF | Calibration certificate |
| RADIATION | CALIBRATION | |
| MEASURING | 8. REPEATED | Dispersion of the |
| STANDARD OR | MEASUREMENTS | readings obtained from |
| PATTERN | OF IBC | measuring standard or |
| | | pattern |
| ROOM | 9. ENVIRONMENTAL | When the room |
| TEMPERATURE | CONDITIONS | temperature causes a |
| | | change in the |
| | | surface and/or cavity |
| CERTIFICATES | 10. DIFFERENT POINTS | Different to calibration |
| | TO CALIBRATE | of the measuring |
| | | standard or pattern |

1. Uncertainty resolution of IBC. Screen resolution of items shown by IBC:

$${u}_{1} = \frac{IBC resolution}{2 \sqrt{3}}$$

2.—Uncertainty repeated measurements of IBC. Obtained by statistical methods and expressed in terms of the sampling standard deviation of the mean (σx):

$${u}_{2} = t \frac{σ}{\sqrt{n}}$$

3.—Uncertainty due to compensation emissivity setting of IBC.

This scheme should be used when the IBC operates at a fixed emissivity value (different from the source) and should calculate the compensation Δ (εIBC) which introduces the thermometer in the displayed value of the measured temperature:

$${u}_{3} = \frac{IBC compensation emissivity}{2 \sqrt{3}}$$

4.—Uncertainty due to radiant source temperature calibration:

$${u}_{4} = \frac{certificate \text{-} source}{2}$$

5.—Uncertainty due to radiant source emissivity calibration:

$${u}_{5} = \frac{certificate \text{-} source}{2}$$

6.—Uncertainty A (radiation area), ε (emissivity) and φ (total radiance). Uncertainty of the measurement of the pyrometer to be measured due to uncertainty of the spectral radiance and emissivity from Stefan Boltzmann equation:

$$If , {U}_{A} = {k}_{A} \cdot A , {U}_{φ} = {k}_{φ} \cdot φ , {U}_{ɛ} = {k}_{ɛ} \cdot ɛ$$

$$then {u}_{9} = {u}_{A , ɛ , φ} = \sqrt{{( \frac{1}{4} )}^{2} ( {k}_{A}^{2} + {k}_{ɛ}^{2} + {k}_{φ}^{2} )} \cdot t$$

Where:

kᵢ are the percentage uncertainties of Area, emissivity and total radiance, respectively, and estimated at a confidence level 1 σ.

t is the measuring temperature.

Noting that the sensitivity coefficient for this model is ¼

7.—Uncertainty due to calibration of the radiation thermometer:

$${u}_{6} = \frac{certificate \text{-} source}{2}$$

8.—Uncertainty of the measuring standard repeated measurements: Obtained by statistical methods and expressed in terms of the sampling standard deviation of the mean (σx):

$${u}_{7} = t \frac{σ}{\sqrt{n}}$$

9.—Uncertainty due to variation of ambient temperature on the environmental conditioning system:

It is caused by temperature changes of the air conditioning system by forced air convection in the calibration area and the radiation source.

An equation of temperature differences between the source and the environment is shown.

$$Δ T = {ɛ}_{S} σ ( {T}_{S}^{4} - ) \frac{d}{K}$$

$$\frac{\partial Δ T}{\partial {T}_{AMB}} = - 4 {ɛ}_{S} σ \frac{d}{K} {T}_{AMB}^{3}$$

$$then {u}_{s} ( T ) = U ( Tamb ) \frac{\partial Δ T}{\partial {T}_{AMB}}$$

10.—Uncertainty due to calibrate the pyrometer at different points that the pattern was calibrated. When measured at different points are estimated from a linear equation, which in turn has an uncertainty:

$${u}_{11} = {u}_{Pd} = \sqrt{( {{t}^{2} ( \frac{U max}{Δ t} )}^{2} + {U}_{max}^{2} )}$$

Where:

t is the calibration point temperature.

Δt is the temperature difference of the calibrated points in the pattern.

Uₘₐₓ is the maximum uncertainty of the calibration points of the pattern.

Applied when calibration is assigned to this model. Uncertainty type B.

In the present invention, it is concluded that the estimated uncertainty calculation for calibration and/or characterization of thermographic equipment is defined as follows:

1. Calibration in temperature:

When the thermal imager is calibrated in temperature using the black body cavity cylindrical, for the reference measuring standard temperature and the temperature reading obtained in the thermal imaging camera, it is had:

e_{ct}=t_{ct}−C_{ε}−tₚ

Where:

e_{ct} is the error obtained in the thermal imaging camera calibration.

t_{ct} is the temperature reading of the thermal imaging camera under repeatability. The uncertainty involved is due to the repeatability of the instrument and the resolution.

C_{ε} is the emissivity correction when it can not adjust the thermal imaging camera to match that of the black body cylindrical cavity. The uncertainty of this parameter is determined by the uncertainty of the effective emissivity of the black body cylindrical cavity, beginning with the emissivity of the walls thereof.

tₚ is the temperature of the black body cylindrical cavity obtained with reference to the pattern pyrometer. The uncertainty is calculated based on the calibration of reference standard pyrometer and temperature measurement errors (uniformity, heat transfer)

2. Calibration of Temperature Differences (Thermal Gradient)

When the temperature differences observed in the thermal imaging camera against temperature differences measured on the disc are calibrated, we have the following model measurement:

e_{Δt}=Δt_{ct}−Δt_{d}−C_{Δt}_{_{d}}−Cₚₜ−C_{ε}

Where:

e_{Δt} is the error in the measured temperature difference with the imager and temperature differences observed in the disk, between two given positions thereof.

Δt_{ct} is the average temperature difference, measured with the thermal imaging camera between two specific positions of the disc.

Δt_{d} is the average temperature difference determined with thermocouples arranged differentially between two points in certain positions of the disc.

C_{Δt}_{_{d}} is corrections of temperature difference defined by thermocouples installation factors, sensitivity corrections due to temperature, convective heat transfer factors.

Cₚₜ is corrections of geometric positions of the thermocouples on the disk and those determined by interpolation of temperature gradients between two points.

C_{ε} is the corrections due to the emissivity such as changes in the same due to temperature.

To better understand the features of the present invention the present description is accompanied as an integral part thereof, drawings with illustrative but not limitative character, which are described below.

### BRIEF DESCRIPTION OF DRAWINGS

FIG. 1 shows a conventional perspective view of the system with better accuracy for calibration and/or characterization of temperature measurement instruments by telemetry, in accordance with the present invention.

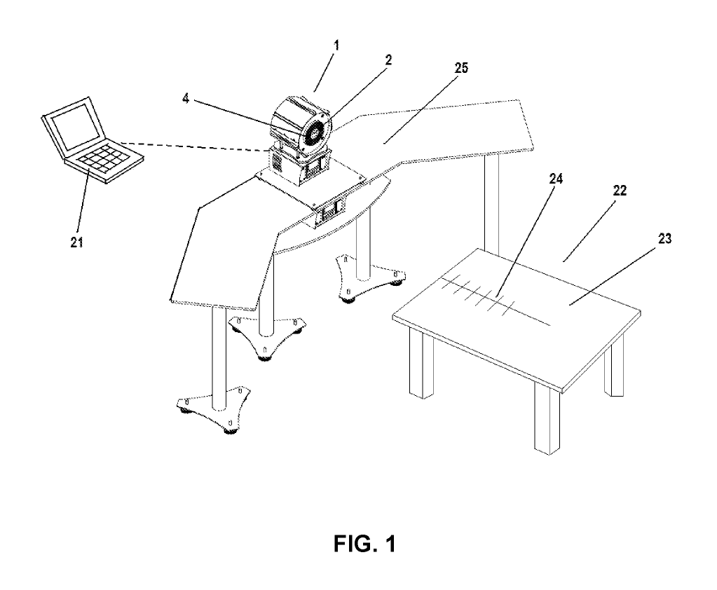

FIG. 2 shows a conventional perspective view of the system with better accuracy for calibration and/or characterization of temperature measurement instruments by telemetry, in the embodiment of three electric furnaces with temperature controller with digital ramp, for calibration and/or characterization measuring equipment in three different temperature ranges.

FIG. 3 shows an exploded prior perspective of an electric furnace with temperature controller with digital, in the invention's system, containing a cylindrical cavity of black body and disc with thermal gradient, in accordance with the present invention.

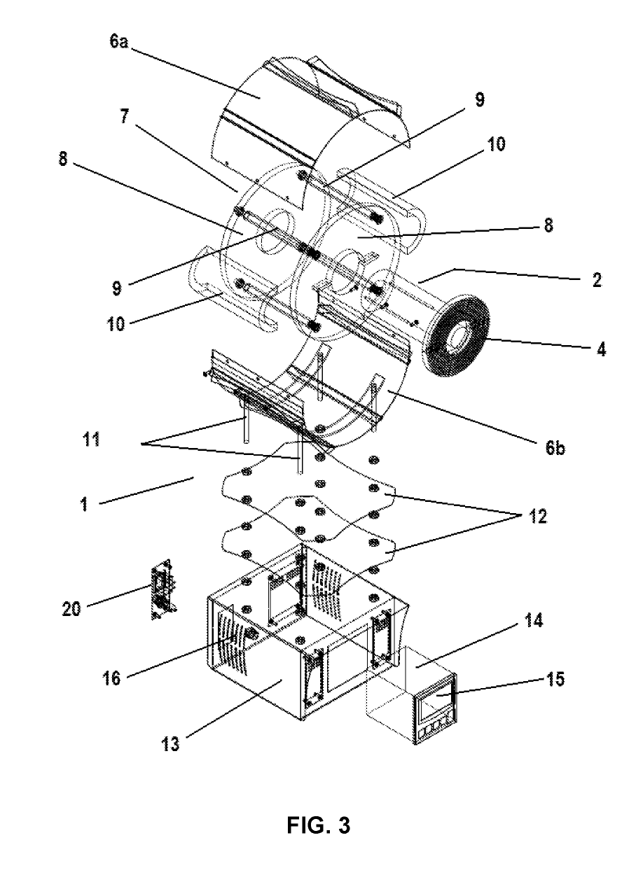

FIG. 4 shows a prior front perspective of an electric furnace with temperature controller with digital ramp, in the invention's system, containing a cylindrical cavity of black body and disc with thermal gradient, in accordance with the present invention.

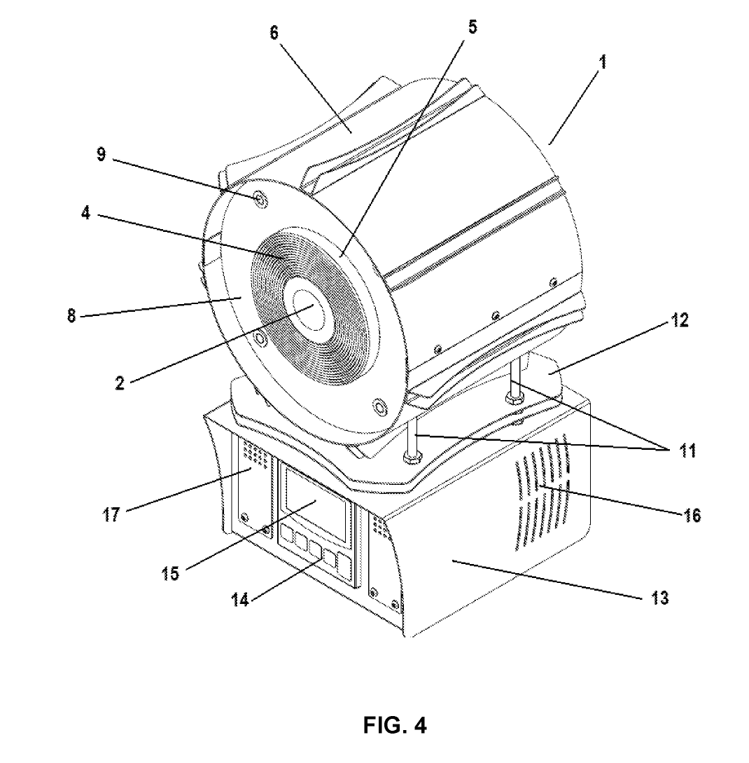

FIG. 5 shows a prior rear perspective of an electric furnace with temperature controller with digital ramp, in the invention's system, containing a cylindrical cavity of black body and disc with thermal gradient, in accordance with the present invention.

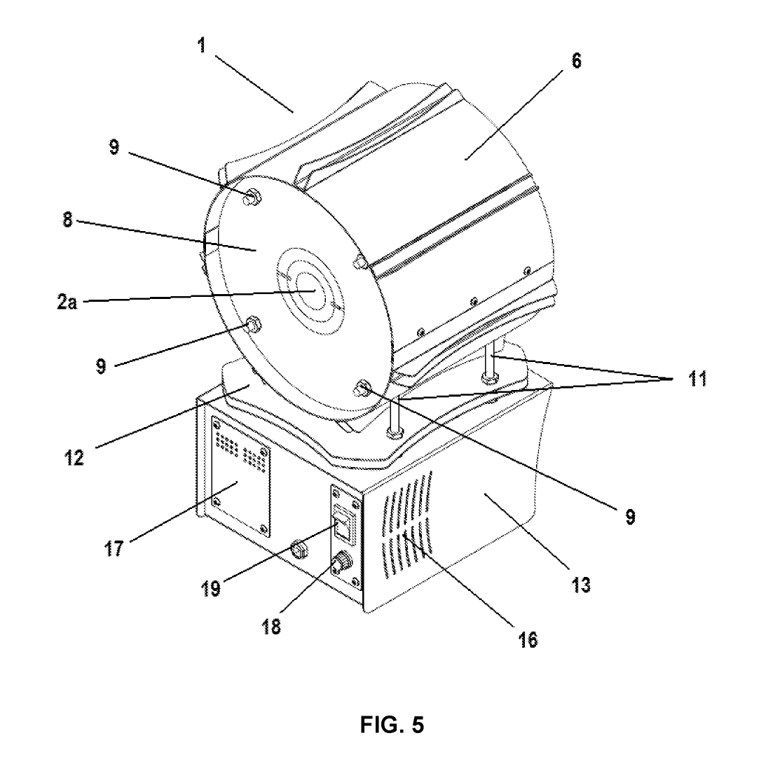

FIG. 6 illustrates a conventional perspective of the cylindrical cavity of black body, with a disc with thermal gradient mechanically linked.

FIG. 7 shows an exploded of the cylindrical cavity of black body, showing the assembly of concentric thermal diffusers metal rings of different diameters in the disc with thermal gradient.

FIG. 8 illustrates a cross section of a concentric thermal diffusers metal rings in the disc with thermal gradient, showing the broached holes for temperature sensors and striatum of the front working surface.

For a better understanding of the invention, it will make the detailed description of some of the embodiments thereof, shown in the drawings appended to the present description, with illustrative but non-limiting purposes.

### DETAILED DESCRIPTION OF THE INVENTION

The characteristic details of the system with better accuracy for calibration and/or characterization of temperature measurement instruments by telemetry, in accordance with the present invention are clearly shown in the following description and the illustrative drawings appended, serving the same reference signs for indicate the same parts.

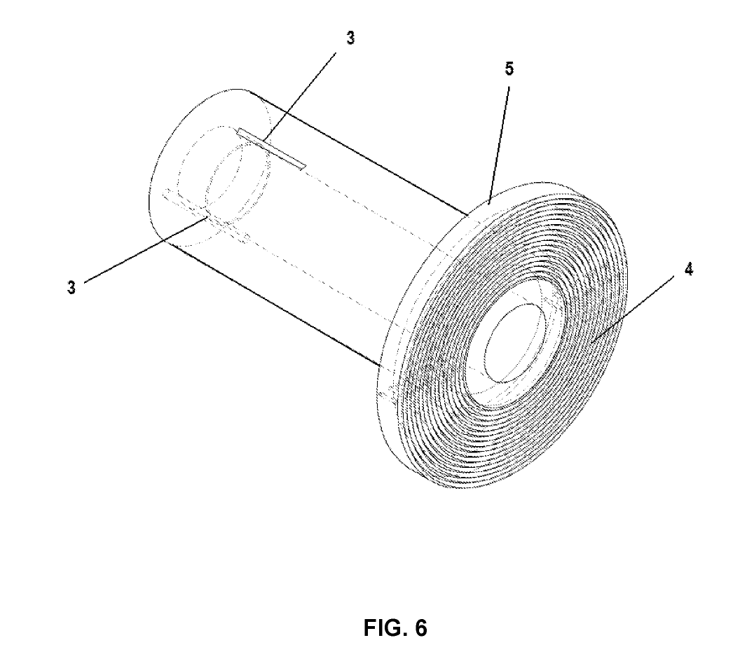

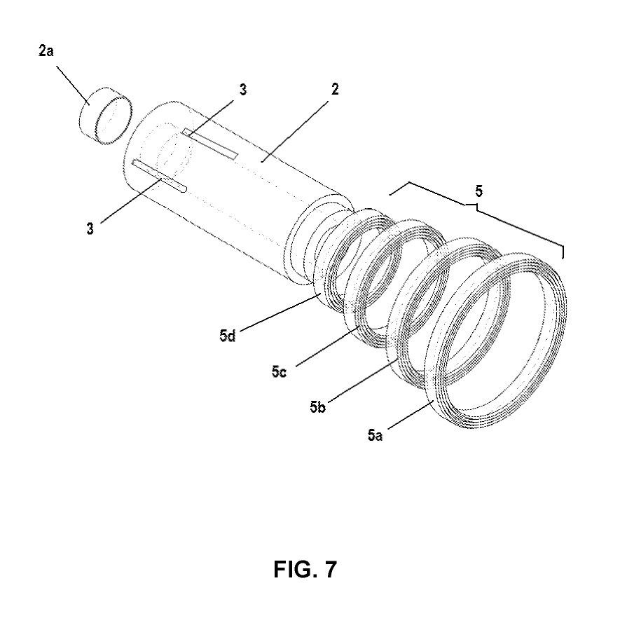

Referring to the drawings 1 and 3 to 7, the system for calibration and/or characterization of temperature measurement instruments by telemetry consists of an electric furnace 1 with temperature controller with digital ramp 14 containing a cylindrical cavity of black body 2 with temperature sensors 3 (see FIG. 6 and FIG. 7) for calibration and traceability of temperature measurements equipment to be calibrated, such as infrared thermometers and thermal imagers; wherein said black body cylindrical cavity 2 comprises around its input a disc with thermal gradient 4 mechanically linked to the said cylindrical cavity of black body 2 and which comprises at least a concentric heat spread metal ring 5, with at least two temperature sensors (not shown) on its smooth back, inserted in at least two broached holes 26, horizontally located with respect to the axial axis of the cylindrical cavity of black body 2 equidistant to the center and inserted into both sides, generate a radial temperature profile staggered by heat loss by convection and radiation in each concentric heat spread metal ring 5, to define temperature profiles with temperature gradient by the thermal contact of the disc with thermal gradient 4, with the cylindrical cavity of black body 2.

With reference to the drawings 3 to 5, said electric furnace with temperature control by digital ramp 1, comprising a housing 6 defined by a concave covers, upper 6a and lower 6b which protects and houses the cylindrical cavity of black body 2 in an enclosure of thermal insulation 7, via annular supports insulation 8 and fastening means 9, wherein said cylindrical cavity black body 2 is heated by an electric heater 10 (shown as two semicircular halves that embraces it) and frontally exposing said disc with thermal gradient 4; said housing comprising six lower supports 11 wherein are mounted heat sinks elements 12 and which are anchored on a control cabinet 13 which houses a controller device temperature digital ramp 14 with display data output 15, ventilation means 16, universal wiring panel 17, fuse elements 18, a switch 19 and a general electrical control 20.

Said temperature controller device with digital ramp 14 comprises a data acquisition system (not shown) where the temperature sensors of said concentric heat spread metal ring 5 of the disc with thermal gradient 4 are connected, and that in turn said data acquisition system (not shown) it is connected to a PC 21 comprising a specialized mathematical computation program for processing information to obtain the behavior of the electric furnace 1, indicating the behavior of the temperature over the time and may know this way, the variables required for determine the value of thermal gradients of the concentric thermal diffuser metal rings 5.

A measurement subsystem 22 for calibration of temperature measurement by telemetry (not shown), disposed opposite said electric furnace 1, comprising a platform 23 with longitudinal graduated scale 24 as distance indicator, which can approach the electric furnace 1 to a minimum distance of 0.15 m, and move away to a distance of 1.5 m; said subsystem is adapted to fit the standard equipment (not shown) and the equipment to be calibrated (not shown) and means for centering and leveling (not shown) the standard equipment and equipment to calibrate to the center of the cylindrical cavity of the black body 2 of electric furnace 1, with which different temperature readings are taken, once the temperature in the electric furnace 1 is stabilized.

At this time, the pattern pyrometer (not shown) measures the temperature of the electric furnace 1, and recorded manually on a PC 21, when the temperature shown on the display data output 15 has been stabilized. Thereupon the temperature is measured with the pattern thermal imager camera (not shown) and recorded manually and a thermal image is taken with a pattern thermal imager camera (not shown) which is stored in its internal memory (not shown) and subsequently downloaded to a PC 21 and finally the instrument to be measured, such as infrared thermometers (not shown) or thermal imagers (not shown) measures the temperature of the electric furnace 1, and recorded manually on a PC 21. This series of steps is repeated at least five times. Temperature measurements from sensors (not shown) located on the back of both concentric thermal diffuser metal rings 5 as those of sensors (not shown) of the cylindrical cavity of black body 2, are electronically acquired through data acquisition system (not shown) and transmitted electronically to a PC 21.

The data collected from the standard equipment, instruments to be measured and sensors (not shown) of temperature of the electric furnace 1, and the readings of the temperatures that define the thermal gradients (taken with the standard thermal camera) of concentric heat diffuser metal rings 5 and disc with thermal gradient 4 fed to said PC 21 and using the computer program, the necessary mathematical calculations are performed to determine the behavior of the instrument to be measured, based calibration method the direct comparison, as with the system of concentric heat diffuser metal rings 5, located on the disk with thermal gradient 4, in addition to know the temperature of the cylindrical cavity of black body 2 and traceability with reference to the standard pyrometer, allows to know the size of the thermal gradient and therefore, the equipment or thermal cameras can be characterized, cause it is known the temperature behavior along the disk with thermal gradient 4, thereby obtaining a profile of radial temperature starting from the center of the cylindrical cavity of black body 2 to the end of the disc with thermal gradient 4.

If the instrument to be measured is a thermal camera (not shown), it is considered an additional step for characterizing the same, which is performed as follows: The standard thermal camera (not shown) picks a thermal image, thereby capturing temperature readings in different positions at frontal side of the electric furnace 1, preferably always is included in measuring at least ⅛ of the center area of the cylindrical cavity of black body 2, whereby the inner detector of the thermographic equipment to be measured (not shown) captures the maximum temperature value in different parts of its area detector (perform a census), thereby achieving determine the behavior of such a instrument's detector, and thus its characterization in different quadrants, determining its behavior. After the thermal image is taken, it is stored in the internal memory and later is downloaded in a PC 21. This picking of thermal images is performed at least four times in different positions covering at least ⅛ of the center area of the cavity black body 2.

Finally, the calibration certificate electronically on the PC 21 is made, considering all the data acquired by the data acquisition system (not shown) and previously transferred to the PC 21. The calibration certificate involves publicize measurements taken during the calibration process and deviations that the instrument to be measured (not shown) has with reference to the standard equipment (not shown), indicating the error that it has and its associated uncertainty based on variables that had affected on the measurement during the calibration process. The estimated mathematical uncertainty, which is associated when calibration method is in temperature, is e_{ct}=t_{ct}−C_{ε}−tₚ. The mathematical estimated uncertainty associated with the method when the calibration is carried out at temperature differences (thermal gradient) is e_{Δt}=Δt_{ct}−Δt_{d}−C_{Δt}_{_{d}}−Cₚₜ−C_{ε}.

The electric furnace 1 is supported on a platform 25 collinearly arranged with respect to the platform 23 of the measurement subsystem 22 for calibration of temperature measurement by telemetry.

The types of cylindrical cavities of black bodies 2 which are used in the present invention are those preferably having the characteristics in the following table:

| | Low | Medium | High |
|---|---|---|---|
| Feature | temperature | temperature | temperature |
| Material | T6 anodized | 35% Zinc | Inconel ® 600 |
| | aluminum | anodized brass | blackened or |
| | | or blackened | Stainless Steel |
| | | | blackened |
| Type of | Cylindrical- | Cylindrical- | Cylindrical- |
| black body | conical | conical | conical |
| cavity | | | |
| Cavity | 38 mm in | 38 mm in | 38 mm in |
| Dimensions | diameter; 190 | diameter; 190 | diameter; 190 |
| | mm deep | mm deep | mm deep |
| Temperature | 50° C. to | 150° C. to | 500° C. to |
| Range | 300° C. | 550° C. | 800° C. |
| Surface | About 1 μm | About 1 μm | About 1 μm |
| Roughness | | | |
| Emissivity | 0.990 | 0.990 | 0.990 |
| (estimated) | | | |
| Temperature | 0.010 | 0.015 | 0.025 |
| stability | | | |

The main reason for selecting these materials is based on its high thermal conductivity, stability in the respective temperature ranges and optimal operating conditions.

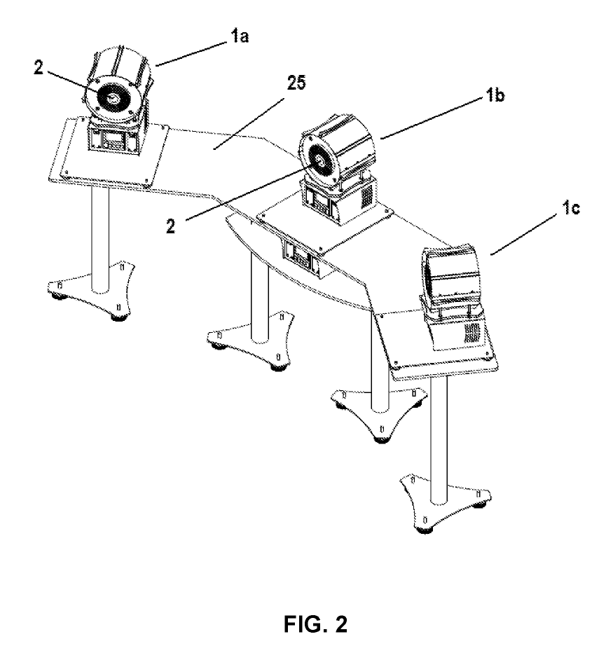

Referring to FIG. 2, the system includes three electric furnaces 1 with temperature controller with digital ramp 14, depending on the measuring range of the equipment to be calibrated, will have an electric furnace 1a for low temperatures between 50° C. to 300° C., an electric furnace 1b for average temperatures between 150° C. to 550° C. and an electric furnace 1c for high temperatures between 500° C. to 800° C., all supported on the platform 25, to calibrate and/or characterize the equipment in temperature ranges from 50° C. to 800° C.

Where the material is made heat spread metal ring 5 of the present invention, it depends on the operating temperature of the electric furnace 1, as shown in the following table:

| Ring | Operating | |
|---|---|---|
| Type | Temperature | Ring Material |
| 5d | 50° C. to | T6 anodized aluminum or |
| | 300° C. | blackened |
| 5b, 5c | 150° C. to | 35% Zinc anodized brass |
| | 550° C. | or blackened |
| 5a | 500° C. to | Inconel ® 600 blackened |
| | 800° C. | or Stainless steel |
| | | blackened |

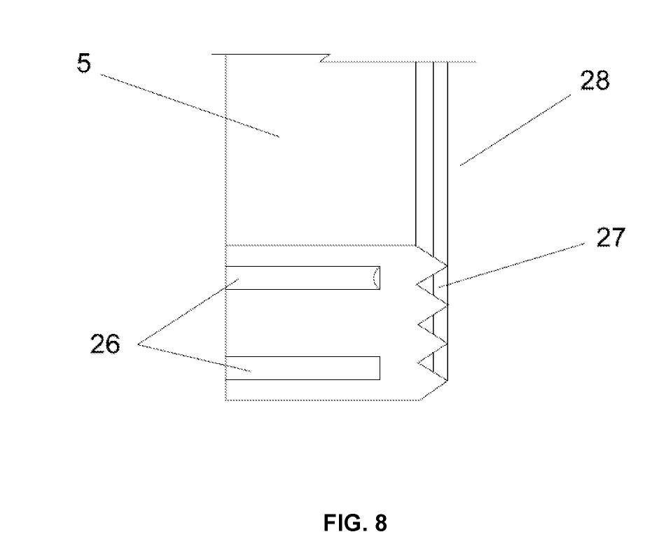

Referring to FIG. 6, FIG. 7 and FIG. 8, the thermal gradient disc 4 is formed by at least one concentric thermal diffuser metal rings 5, in the present invention are preferred at least four concentric thermal diffuser metal rings (5a, 5b, 5c and 5d) mechanically assembled on the disk with thermal gradient 4, which in their preferred embodiment has the following diameters:

| | External diameter | Internal diameter |
|---|---|---|
| Ring | (mm) | (mm) |
| 5a | 142.5 | 122.5 |
| 5b | 122.5 | 102.5 |
| 5c | 102.5 | 82.5 |
| 5d | 82.5 | 62.5 |

Each of said concentric thermal diffuser metal rings 5a, 5b, 5c and 5d comprise four broached holes 26 disposed diametrically and horizontally to the axial axis, for accommodating at least two temperature sensors (not shown). In the present invention realization are preferred four temperature sensors (not shown), for capturing temperature points for each concentric thermal diffuser metal ring 5a, 5b, 5c and 5d, where the temperature sensors consist of thermocouples type “J” or “T”.

To quantify thermal gradients, temperatures of the thermocouples of each concentric thermal diffuser metal rings 5a, 5b, 5c and 5d are measured.

The temperature gradient is radial generated in the disc with thermal gradient 4, comprising said concentric thermal diffuser metal rings 5a, 5b, 5c and 5d.

Thermal gradients are quantized as follows:

Gradient=ΔT/ΔL

Where ΔT is the temperature difference between two consecutive points and ΔL is the distance between those two consecutive points. The temperature difference is mainly measured with calibrated thermocouples located at the back of concentric thermal diffuser metal rings 5. The distance between two consecutive points is known from the design and construction of such concentric thermal diffuser metal rings 5.

FIG. 7 shows that the cylindrical cavity of black body 2 comprises a cap insert 2a for sealing the rear end or bottom of the cylindrical cavity of black body 2 and having a concave shape on its outer face; said concave surface is positioned within the cylindrical cavity of the black body 2. The side holes where the temperature sensors 3 are arranged in said cylindrical cavity of black body 2, are 50 mm to 100 mm and preferably 50 mm.

FIG. 8 shows that these concentric rings 5 comprise a grooved triangular shaped 27 on its outer surface of the front working face 28, shown as triangular grooves (equilateral) in cross section, that avoid reflections in the same.

The invention has been sufficiently described so that a person of ordinary skill in the field of art could reproduce and obtain the results mentioned herein. Likewise, any skilled person in the field of art to which belongs the present invention may be able to make modifications not described in this application, so if for implementing such changes in a particular structure or process manufacturing thereof requires the subject matter claimed in the following claims, such structures and processes must be within the scope of this invention.

Having sufficiently described the invention is claimed as the property contained in the following clauses claiming ownership:

1. A system for calibration and/or characterization of temperature measurement instruments by telemetry, characterized by comprising at least an electric furnace with temperature controller with digital ramp containing a cylindrical cavity of black body with temperature sensors, wherein said cylindrical cavity of black body comprises mechanically linked around the cavity entrance disc with thermal gradient, and comprises at least one concentric thermal diffuser metal ring, with at least two temperature sensors on its smooth back, inserted in, at least two broached holes, located horizontally with respect to the axial axis of the cylindrical cavity black body and equidistant from its center, inserted on both sides; it comprises a housing that protects and accommodates the cylindrical cavity of the black body, through brackets thermal insulated in an enclosure thermal insulation, positioning it, by means of guides, in the center of the housing and exposing it on the front side of the oven electric; generating a radial temperature profile staggered by heat loss by convection and radiation in each concentric thermal diffuser metal ring, to define temperature profiles with temperature gradient by the thermal contact of the disc with the cylindrical cavity of black body that is heated with an electric heater; wherein said electric furnace comprises a self-adjusting temperature controller device with digital ramp with a data acquisition system, where connect the temperature sensors of said concentric thermal diffuser metal rings, and that in turn said data acquisition system is connected to a PC comprising a specialized mathematical computation program that processes information to obtain the behavior of the electric oven; subsystem for positioning and measurement for calibration and/or characterization of equipment temperature measurement by telemetry disposed opposite said at least one electric furnace, consisting of a platform with longitudinal graduated scale as an indicator of distance, adapted to mount the pattern equipment and equipment to be calibrated, with means for centering and leveling the measuring standard and equipment to be calibrated to the center of the black body of the electric furnace equipment, with which is captured readings of stabilized temperature from measuring standard, equipment to be calibrated and the temperature of the electric furnace shown in the screen; and wherein the collected data is fed to the PC mentioned, along with temperature readings that define the thermal gradients of concentric thermal diffuser metal rings on the disk with thermal gradient and by the mathematical calculation program generates an average temperature, which is compared with standard pyrometer temperature and thus, the measurement error is determined, further mathematical calculations required to determine the estimated uncertainty associated with the measurement method; because through the disc with thermal gradient, comprising at least one concentric thermal diffuser metal ring, besides knowing the temperature of the cylindrical cavity of black body and traceability with reference to national or international standards through calibration standard pyrometer, It allows to know the behavior of the temperature along the thermal gradient disc; thereby obtaining a temperature profile that allows you to calibrate and/or characterize, by direct comparison, the temperature measuring instruments by telemetry.

2. The system calibration and/or characterization of instruments temperature measurement by telemetry according to claim 1, characterized in that said electric furnace with temperature controller with digital ramp, comprising a housing that protects and accommodates the cylindrical cavity black body in an enclosure thermal insulation through brackets thermal insulation, positioning by means of guides, in the center of the housing and exposing on the front side of the oven, joining the disc with thermal gradient, comprising at least one concentric thermal diffuser metal ring, into the cylindrical cavity of black body; said housing comprising bottom brackets where heat sinks elements are mounted and which are anchored on a control cabinet housing a temperature controller device digital ramp, capable of self-adjustment and display data output; further comprising ventilation means, universal wiring panel, fuse elements, switch and a general electrical control.

3. The system calibration and/or characterization of instruments temperature measurement by telemetry according to claim 1, characterized in that the cylindrical cavity of said black body comprises two temperature sensors located in the rear of the black body cavity, located in broached holes.

4. The system calibration and/or characterization of instruments temperature measurement by telemetry according to claim 1, wherein said disc thermal gradient is formed by at least one concentric thermal diffuser metal ring preferably four concentric thermal diffuser metal rings arranged concentrically contacted each other; where heat is transferred from the cylindrical cavity black body towards the ends of the concentric thermal diffuser metal rings through thermal contact creating a thermal resistance which depends on the contact pressure, surface finish and thermal properties of rings in contact; which provides a temperature difference of about 100° C., which generates a series of temperature “steps” at the contact interface, between the concentric thermal diffuser metal rings and the interface outside, a soft profile thermal gradient is created in the radial direction, useful for calibration.

5. The system calibration and/or characterization of instruments temperature measurement by telemetry according to claim 4, characterized in that each concentric ring comprises at least two broached holes, disposed diametrically to accommodate at least one temperature sensor for each hole encountered, for taking temperature for each concentric thermal diffuser metal ring.

6. The system calibration and/or characterization of temperature measurement instruments by telemetry according to claim 5, wherein said temperature sensors consist of thermocouples type “J” or “T”.

7. The system calibration and/or characterization of instruments temperature measurement by telemetry according to claims 1, 4 and 5, characterized in that said concentric thermal diffuser metal rings, are made of a material selected from the group consisting of aluminum, brass, Inconel® or metal alloy as Inconel® comprising the higher percentage Nickel, but also contains: chromium, iron, carbon, manganese, sulfur, silicon and copper; or stainless steel, given its high thermal conductivity and stability in the temperature range.

8. The system calibration and/or characterization of instruments temperature measurement by telemetry according to claims 1, 4, 5 and 7, wherein the surfaces of said concentric thermal diffuser metal rings are blackened in order to increase its emissivity.

9. The system calibration and/or characterization of instruments temperature measurement by telemetry according to claims 7 and 8, characterized in that the blackening of the surface of said concentric thermal diffuser metal rings achieved by the methods of dark anodized rings made aluminum, oxidized and black paint for rings made of brass, Inconel® and stainless steel, and/or surface oxidized at high temperatures to rings made of Inconel®.

10. The system calibration and/or characterization of instruments temperature measurement by telemetry according to claims 1, 4, 5 and 7 to 9, characterized in that said concentric thermal diffuser metal rings comprise a grooved triangular profile on its outer surface its front working face, shown as triangular grooves (equilateral) in cross section.

11. The system calibration and/or characterization of temperature measurement instruments by telemetry according to claim 4, wherein the thickness of said concentric rings is preferably 20 mm.

12. The system calibration and/or characterization of instruments temperature measurement by telemetry according to claims 1 to 3, wherein the heater and said cylindrical cavity of black body are thermally insulated by ceramic fiber low density and low thermal conductivity placed around these.

13. The system calibration and/or characterization of instruments temperature measurement by telemetry according to claims 1 and 12, wherein said heater is made up of two pieces in half-round, hugging completely the outside of the cylindrical cavity of body black.

14. The system calibration and/or characterization of temperature measurement instruments by telemetry according to the preceding claims, characterized in that encompasses a range of temperatures for calibration of temperatures in the range of 50 to 800° C.

15. The system calibration and/or characterization of instruments temperature measurement by telemetry according to claim 14, comprising three electric ovens with temperature controller in digital ramp, an oven for low temperatures of 50 to 300° C., an oven for medium temperatures of 150 to 550° C. and a oven for high temperature 500 to 800° C.

16. The system calibration and/or characterization of instruments temperature measurement by telemetry according to claim 14, characterized in that between the platform with graduated longitudinal scale, as an indicator of distance from said positioning subsystem and measurement for calibration of temperature measurement telemetry disposed opposite said at least one electric oven, can be approximated to the electric furnace to a minimum distance of 0.15 m away to a distance of 1.5 m.

17. A calibration method and/or more accurate characterization of temperature measuring instruments by telemetry, characterized by comprising the steps of:
1) Turn on the oven and is programmed with the first temperature required to calibrate, using the temperature controller with digital ramp;
2) Wait long enough for the electric furnace reaches stability time;
3) Place measuring standard or reference equipment (P) and the instrument to measure (IBC) in the positioning and measuring subsystem, checking that both measuring instruments have been programmed to the same emissivity.
4) Place the support to the selected proper distance according to the visual field, align and to level in direction to the cylindrical cavity of black body of the electric furnace.
5) Perform a positioning test using a laser pointer for alignment, ensuring that the centers of both standard equipment (P) such as the instrument to be measured (IBC) and the center of the cylindrical cavity of black body are aligned with reference to its center.
6a) In the case of calibration infrared radiation thermometers, readings shall be taken as follows:
(LP-LIBC-libc-LP-LP-LIBC-LIBC-LP-LP-LIBC-LIBC-LP), where: LP corresponds to the standard pyrometer reading and LIBC corresponds to the reading of the instrument to be calibrated.
6b) In the case of calibrating thermographic equipment or thermal imagers, readings shall be taken as follows: (LP-CP-LIBC-LIBC-CP-LP-LP-CP-LIBC-LIBC-CP-LP-LP-CP-LIBC-LIBC-CP-LP), where: CP corresponds to the reading of the measuring standard thermal imaging camera.
7) Is recorded the room temperature near the IBC instrument, at the beginning and end of each measurement point. Also consider record the value of the emissivity, which is working, the spot used, the actual distance position to the cylindrical cavity of black body and its spectral response of the IBC instrument.
8) Is measured with different measuring instruments: In a first moment, the standard pyrometer measures the temperature of the electric furnace, and recorded manually on a PC, when the temperature shown on the data output display has been stabilized. Thereupon, the temperature is measured with a standard thermal imaging camera and recorded manually and takes a thermal image with a standard thermal imaging camera, which is stored in its internal memory and then downloaded to a PC. Finally the instrument to be measured, such as infrared thermometers or thermal imagers, measures the temperature of the electric furnace, and recorded manually on a PC.
9) Repeat this series of steps at least five times and carry out the corresponding temperature records.
10) The temperature measurements from the sensors, located on the back of both concentric thermal diffuser metal rings, as the sensors of the cylindrical cavity of black body 2, are electronically acquired by the data acquisition system and transmitted so electronics to a PC.
11) Data collected by measuring standard equipment, instruments to be measured and sensor temperature of the electric furnace, and the temperature readings which define the thermal gradients (taken with standard thermal imaging camera) of concentric thermal diffuser metal rings of the disc with thermal gradient are fed to this PC and using the computer program, the necessary mathematical calculations are performed to determine the behavior of the instrument to be measured, based calibration method the direct comparison, because of the system of concentric thermal diffuser metal rings located on the disk with thermal gradient, besides knowing the temperature of the cylindrical cavity of black body and traceability with reference to the standard pyrometer, allows to know the size of the thermal gradient and therefore may be characterized thermal cameras or thermographic equipment, because the behavior of the temperature along the thermal gradient disc is known. Thereby is obtained radial temperature profile starting from the center of the cylindrical cavity of black body, until the end of the disc with thermal gradient.

18. The calibration method and/or characterization of more accurate temperature measurement instruments by telemetry according to claim 17, wherein if the instrument to be measured is a thermal camera, further comprising:
i) The thermal camera standard, taking a thermal image, capturing thus temperature readings from the front electric furnace, in different positions, preferably always be included in measuring at least ⅛ of the center area of the cylindrical cavity of black body, with which the detector thermographic equipment to be measured will capture (will census) the maximum temperature in different parts of its area detector, thereby achieving determine the behavior of the detector of the instrument to be calibrated and thus its characterization in different quadrants, determining their behavior.
ii) After being taken thermal image is stored in the internal memory and later downloaded to a PC.
iii) This jack thermal imaging is performed at least four times in different positions, covering at least ⅛ of the downtown area of the black body cavity.
iv) To elaborate the calibration certificate electronically, considering all the data acquired by the data acquisition system and transferred to the PC. This document involves making known the measurements taken during the calibration process and deviations that the instrument to be measured has with reference to the standard equipment, specifying the error that it has and its associated uncertainty based on variables that had affectation on the measurement during the calibration process.

19. The method of calibration and/or characterization more accurately measuring instruments temperature by telemetry according to claims 17 and 18, characterized in that the uncertainty estimated, associated with it the method when calibrated in temperature, is the result of the temperature reading imager under repeatability conditions minus the correction of emissivity less than the temperature of the cylindrical cavity black body obtained by reference to standard pyrometer.

20. The method of calibration and/or characterization more accurately measuring instruments temperature telemetry according to claims 17 and 18, characterized in that the estimated uncertainty, which is associated with the method when the calibration is performed in differences temperature (temperature gradient) is the average difference of temperature measurements between two specific positions of the disc with thermal gradient taken with the thermal imaging camera, minus the average temperature difference determined with thermocouples arranged differentially between two points in certain positions of the disc with gradient heat, minus corrections of temperature's difference determined by factors of thermocouple's installation, sensitivity corrections due to temperature, convective heat transfer factors, minus the corrections of the geometric positions of the thermocouples on the disk and determined by interpolation temperature gradients between two points, minus corrections due to emissivity such as changes in the same due to temperature.
